(19) United States
(12) Patent Application Publication
(10) Pub. No.: US 2006/0153976 A1
(43) Pub. Date: Jul. 13, 2006

(54) Magnetic recording medium and hard disk drive using the same, and manufacturing method thereof

(75) Inventors: Kenchi Ito, Kokubunji (JP); Susumu Soeya, Kodaira (JP); Yuko Tsuchiya, Tokorozawa (JP)

Correspondence Address: REED SMITH LLP, Suite 1400, 3110 Fairview Park Drive, Falls Church, VA, 22042, US

(73) Assignee: Hitachi, Ltd.

(21) Appl. No.: 11/374,158

(22) Filed: Mar. 14, 2006

Related U.S. Application Data
(62) Division of application No. 10/456,619, filed on Jun. 9, 2003.

(30) Foreign Application Priority Data
Sep. 18, 2002 (JP) 2002-270895

(51) Int. Cl. B05D 5/12

(52) U.S. Cl. 427/127; 427/180

(57) ABSTRACT

A magnetic recording medium, a hard disk using the same, and a manufacturing method thereof are provided. In one example, the magnetic nano-particle medium is formed by depositing a magnetic nano-particle colloid on a substrate, wherein the axes of easy magnetization of respective crystalline particles are aligned with high accuracy. A layer of L10 alloy nano-particles which will exhibit magnetic properties through an order-disorder transition, and arranged at a substantially uniform spacing on a substrate, and a carbon-containing covering film for surrounding these nano-particles and making the spacing substantially uniform are provided. To the L10 alloy of the nano-particles, at least one non-magnetic element is added, or a covered layer comprising at least one non-magnetic layer is formed therearound. This makes it possible to implement a magnetic recording medium wherein the average diameter of nano-particles is small, and the nano-particle diameter dispersion is small, and the axes of magnetic anisotropy are aligned.

### CROSS-REFERENCE TO RELATED APPLICATION

This application is a Divisional of U.S. application Ser. No. 10/456,619 filed Jun. 9, 2003. This application claims priority to U.S. application Ser. No. 10/456,619 filed Jun. 9, 2003, which claims priority to Japanese Patent Application No. 2002-270895 filed Sep. 18, 2002, the contents of which are hereby incorporated by reference into this application.

### BACKGROUND OF THE INVENTION

1. Field of the Invention

The present invention generally relates to recording mediums and, more particularly, to a magnetic recording medium, a manufacturing method thereof and a hard disk drive equipped with the same.

2. Discussion of Background

The real recording density of a hard disk drive has been steadily increasing, and is expected to reach 100 Gb/in.² by 2003. However, if the bit length to be recorded decreases due to a further increase in density, the diameter of crystalline particles constituting a recording medium is required to be further decreased in order to keep the signal to noise ratio of the signal recorded on the medium. The reduction in diameter of the crystalline particles, however, increases the thermal instability of magnetization of the medium. Unfavorably, this, in turn, causes the recorded signals to vanish.

In particular, when the particle diameter dispersion of the crystalline particles is large, unfavorably, the recorded magnetization signal of the crystalline particles with a smaller particle diameter vanishes even if the crystalline particles of an average particle diameter are resistant to thermal instability. Namely, to meet the further increase in density, it is essential to develop a magnetic recording medium made up of crystalline particles with a smaller average diameter and a smaller particle diameter dispersion.

As a technology for solving the problem, for example, the following method as described in Appl. Phys. Lett., Vol. 75, No. 20, pp. 3162-3164 (1999) is proposed as a first method using a conventional sputtering process: FePt particles having a high anisotropy constant are sputtered simultaneously with SiO₂ to form a granular film of FePt and SiO₂, so that a FePt medium with a particle diameter of not more than 10 nm is formed.

Whereas, in Journal of the Magnetics Society of Japan, Vol. 25, pp. 847-850, (2001), there is disclosed a second method: FePt nano-particles are deposited very thinly to a thickness of not more than 4 nm on a MgO underlayer. This induces the island growth of the FePt nano-particles, so that FePt nano-particles with a particle diameter of not more than 10 nm are formed. Further, in Abstracts of the 25th Annual Conference of the Magnetics Society of Japan, p. 23, (2001), there is described another method obtained by improving this method, in which the film thickness is increased by multilayer film growth.

These methods are the methods for manufacturing a medium by a sputtering process conventionally used in manufacturing of a medium. In Science, Vol. 287, pp. 1989-1992, (2000), there is disclosed a third method: a FePt nano-particle colloid is chemically synthesized, and expanded and self-assembled on a substrate to form a magnetic recording medium in which the average diameter of nano-particles and the nano-particle diameter dispersion are 5 nm and not more than 10%, respectively, both of which have been largely reduced from those of the existing magnetic recording media. Further, a detailed description on the third method is found in JP-A Nos.48340/2000 and 54012/2000.

However, the proposed methods in the prior art present the following problems. With the first method using a granular film, it is possible to manufacture crystalline particles with smaller particle diameter. However, it is difficult to reduce the dispersion of particle diameters. Further, in order to make the crystalline particles commercially available as a medium, the axes of magnetic anisotropy of the respective crystalline particles are required to be aligned in a certain direction with high accuracy. However, this is difficult to achieve with this method. In a recent year, in Appl. Phys. Lett., Vol. 77, No. 14, pp. 2225-2227 (2000), there has been disclosed a method in which the axes of easy magnetization of FePt are aligned perpendicular to the substrate plane using B₂O₃ in place of SiO₂. However, a method for reducing the particle diameter dispersion is not disclosed therein.

With the second method, FePt nano-particles are deposited very thinly on an underlayer through island growth by a sputtering process, and the grown nano-particles are stacked in multilayered structure to form a medium. It is reported that the nano-particle diameter of the medium is increased by the heat treatment for inducing the magnetization of the FePt nano-particles with the second method.

With the third method in which a chemically synthesized FePt nano-particle colloid is self-assembled on a substrate to manufacture a medium, it is possible to achieve the reductions in average diameter of nano-particles and nano-particle diameter dispersion. However, the axes of magnetic anisotropy of the respective crystalline nano-particles are oriented at random.

### SUMMARY OF THE INVENTION

It is an object of the present invention to reduce the average diameter of nano-particles and the nano-particle diameter dispersion.

It is another object of the present invention to develop a method for aligning the axes of magnetic anisotropy of the nano-particles with high accuracy.

In accordance with the present invention, it is possible to implement a nano-particle medium with a high magnetic anisotropy energy wherein the average diameter of nano-particles and the nano-particle diameter dispersion are very small, and the axes of easy magnetization of the nano-particles are aligned. Therefore, it is possible to implement a hard disk drive using the same medium, which is thermally stable, and exhibits a high resolution and a super-high recording density.

In the present invention, a magnetic recording medium in which the average diameter of nano-particles and the nano-particle diameter dispersion have been both largely reduced from those of the existing magnetic recording media is formed by employing the foregoing third method. Namely, an alloy nano-particle colloid is chemically synthesized so that alloy nano-particles with an average nano-particle diameter of not less than 1 nm and not more than 20 nm, and a nano-particle diameter dispersion of not more than 10% are surrounded by an organic compound, and arranged at a substantially uniform spacing. The resulting alloy nano-particle colloid is caused to undergo a so-called self-assembling on a substrate to form a magnetic recording film.

The alloy nano-particles immediately after chemical synthesis are non-magnetic. For example, in the case of FePt nano-particles, the nano-particles are required to undergo an order-disorder transition in crystal structure by a high temperature heat treatment at not less than 550° C., and thereby to exhibit magnetic properties. However, at such a high ordering temperature, the organic compound surrounding the nano-particles is solidified before the nano-particles exhibit magnetic properties. As a result, the nano-particles are fixed with their axes of easy magnetization oriented in random directions. Therefore, it is difficult to align the axes of easy magnetization uniformly in a desired direction even if a prescribed magnetic field is externally applied thereto. Whereas, for a perpendicular magnetic recording medium in which a magnetic recording film is formed on a substrate with a soft magnetic underlayer interposed therebetween, if a high temperature heat treatment is performed for causing a desired magnetization of the magnetic recording film, the magnetic characteristics of the soft magnetic underlayer is adversely affected. As a result, it becomes impossible to expect the effects of the provision of the soft magnetic underlayer to be produced. Therefore, it is difficult to form a magnetic recording film having desirable magnetic characteristics. Thus, it is difficult to obtain a perpendicular magnetic recording medium adaptable to high recording density in which the average diameter of nano-particles is small, and the nano-particle diameter dispersion is small, and further, the axes of magnetic anisotropy are aligned.

In the present invention, the ordering temperature at which the alloy nano-particles undergo an order-disorder transition to exhibit magnetic properties is made lower than the stiffness temperature of the organic compound surrounding the nano-particles. Thus, the nano-particles are applied with a prescribed magnetic field while exhibiting magnetic properties through the order-disorder transition. As a result, the organic compound is solidified with the axes of easy magnetization of the alloy nano-particles aligned substantially uniformly along a specific direction.

In accordance with the present invention, it is possible to obtain a magnetic- recording medium, which comprises: a substrate; and a magnetic recording layer formed on the substrate, the magnetic recording layer comprising an organic compound and alloy nano-particles surrounded by the organic compound and arranged at a substantially uniform spacing, the alloy nano-particles undergoing a transition into an ordered structure at a lower temperature than the stiffness temperature of the organic compound to exhibit magnetic properties, wherein the organic compound has been solidified with the axes of easy magnetization of the alloy nano-particles aligned substantially uniformly along a specific direction with respect to the substrate plane.

In the present invention, there is provided a magnetic recording medium, which comprises: a substrate; a layer of L10 alloy nano-particles arranged at a substantially uniform spacing on the substrate, and exhibiting magnetic properties through an order-disorder transition; and a carbon-containing covering film surrounding the nano-particles for making the spacing between the nano-particles substantially uniform. To the L10 alloy of the magnetic nano-particles, at least one non-magnetic element has been added. Alternatively, a covered layer comprising at least one non-magnetic element has been formed therearound. This implements a magnetic recording medium using a magnetic recording layer comprising alloy nano-particles with a small average diameter of nano-particles and a small nano-particle diameter dispersion, and further with the axes of magnetic anisotropy aligned uniformly along a desirable direction. In particular, the temperature causing the magnetic L10 alloy nano-particles to undergo an order-disorder transition and thereby to exhibit magnetic properties is made lower than the stiffness temperature of the organic compound surrounding the alloy nano-particles, for example, the temperature is lowered to not more than 300° C. This implements the uniform alignment of the axes of magnetic anisotropy of the nano-particles.

Further, each of the L10 alloy nano-particles is composed of a material comprising an alloy of any of Fe and Co and any of Pt and Pd as a base, and any of Cu, Sn, Pb, Sb, and Bi added thereto. Still further, the content of Cu, Sn, Pb, Sb, or Bi to be added of the L10 alloy nano-particles is set in a range of 5 to 20%. Alternatively, each of the L10 alloy nano-particles is so configured that an alloy of any of Fe and Co and any of Pt and Pd is included as a core, and any element of Cu, Sn, Pb, Sb, Bi, and Ag surrounds therearound.

Further, the axes of easy magnetization of the alloy nano-particles are set along any predetermined, specific direction of the directions at angles of roughly 0 degrees, roughly 45 degrees, and roughly 90 degrees with respect to the substrate plane. In particular, the magnetic recording medium is composed of a nano-particle layer wherein the axes of easy magnetization of the nano-particles are at an angle of roughly 45 degrees or roughly 90 degrees with respect to the substrate plane, a substrate, and a soft magnetic underlayer.

Further, a hard disk drive is comprised of a magnetic recording medium wherein the axes of easy magnetization are aligned at an angle of roughly 0 degrees with respect to the substrate plane; and a merged-type-magnetic head composed of a reader using a magneto-resistive effect and a writer in a ring form. Alternatively, a hard disk drive is comprised of a magnetic recording medium so configured that a nano-particle layer, wherein the axes of easy magnetization are aligned at an angle of roughly 45 degrees or roughly 90 degrees with respect to the substrate plane, is formed on a substrate with a soft magnetic layer interposed therebetween; and a merged-type-magnetic head composed of a reader using a magneto-resistive effect and a single-pole-type writer for perpendicular magnetic recording.

Further, a hard disk drive comprises: the above-described magnetic recording medium, an energy generation means for applying a recording energy to the magnetic recording medium; an energy focusing means for focusing the recording energy onto the recording medium; a magnetic field generation means for generating a magnetic field in the vicinity of the focus position of the recording energy; and a reader using a magneto-resistive effect for reproducing a signal recorded on the recording medium. In particular, a light with a wavelength of 350 to 1600 nm is used as the means for applying a recording energy to the magnetic recording medium.

The magnetic recording medium in accordance with the present invention is manufactured by the following method. The method comprises the steps of: chemically synthesizing alloy nano-particles in such a state as to be surrounded by a covering of a carbon-containing organic compound, the alloy nano-particles undergoing a transition into an L10 structure through an order-disorder transition to exhibit magnetic properties, each of the alloy nano-particles comprising at least one non-magnetic element added thereto, or each of the alloy nano-particles being so configured that an L10 alloy core is surrounded by a covering film comprising at least one non-magnetic element; applying the nano-particles onto a substrate; heat-treating a nano-particle film applied on the substrate so as to cause the nano-particles to undergo an order-disorder transition and thereby to exhibit magnetic properties while applying a magnetic field in a specific direction to the alloy nano-particles; and solidifying (ex., carbonizing) the organic compound surrounding the nano-particles at a higher temperature than the temperature causing the order-disorder transition.

The invention encompasses other embodiments of a method and apparatus, which are configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1A is a cross-sectional view of an example of a magnetic recording medium, in accordance with the present invention;

FIG. 1B is a cross-sectional view of an example of a magnetic recording medium, in accordance with the present invention;

FIG. 1C is a cross-sectional view of an example of a magnetic recording medium, in accordance with the present invention;

FIG. 2A is part of a schematic diagram for illustrating the principle of the lowering in ordering temperature to be used in the present invention;

FIG. 2B is part of a schematic diagram for illustrating the principle of the lowering in ordering temperature to be used in the present invention;

FIG. 2C is part of a schematic diagram for illustrating the principle of the lowering in ordering temperature to be used in the present invention;

FIG. 2D is part of a schematic diagram for illustrating the principle of the lowering in ordering temperature to be used in the present invention;

FIG. 3 is a transmission electron microscope photograph of the magnetic recording medium in accordance with the present invention;

FIG. 4A is a schematic diagram for showing one example of a method for manufacturing the magnetic recording medium of the present invention;

FIG. 4B is a schematic diagram for showing one example of a method for manufacturing the magnetic recording medium of the present invention;

FIG. 4C is a schematic diagram for showing one example of a method for manufacturing the magnetic recording medium of the present invention;

FIG. 4D is a schematic diagram for showing one example of a method for manufacturing the magnetic recording medium of the present invention;

FIG. 5 shows a temperature control profile in manufacturing of the magnetic recording medium of the present invention;

FIG. 6 is a schematic diagram for showing a part of a hard disk drive composed of an example of the magnetic recording medium of the present invention wherein the direction of the axes of easy magnetization is at an angle of roughly 0 degrees with respect to the substrate plane, and an in-plane magnetic recording head;

FIG. 7 is a schematic diagram for showing a part of another example of the hard disk drive of FIG. 6, wherein a reader of a CPP structure is used as-the reader in FIG. 6;

FIG. 8 is a schematic diagram for showing a part of a hard disk drive composed of an example of the magnetic recording medium of the present invention wherein the direction of the axes of easy magnetization is at an angle of roughly 90 degrees with respect to the substrate plane, and a writer for perpendicular magnetic recording;

FIG. 9 is a schematic diagram for showing a part of a hard disk drive composed of an example of the magnetic recording medium of the present invention wherein the direction of the axes of easy magnetization is at an angle of roughly 45 degrees with respect to the substrate plane, and a writer for perpendicular magnetic recording;

FIG. 10 is a cross-sectional view of a magnetic nano-particle of a core-shell structure;

FIG. 11 is a schematic diagram for showing a part of a hard disk drive equipped with a heat-assisted type writer for perpendicular magnetic recording;

FIG. 12A is part of a schematic diagram of a hard disk drive equipped with the writer for perpendicular magnetic recording of the present invention; and

FIG. 12B is part of a schematic diagram of a hard disk drive equipped with the writer for perpendicular magnetic recording of the present invention.

### DESCRIPTION OF THE PREFERRED EMBODIMENTS

An invention for a magnetic recording medium, hard disk drive using the same and manufacturing method thereof is disclosed. Numerous specific details are set forth in order to provide a thorough understanding of the present invention. It will be understood, however, to one skilled in the art, that the present invention may be practiced without some or all of these specific details.

Prior to the explanation of examples of the present invention, a description will be given to the principle of the lowering of the ordering temperature for use in the present invention.

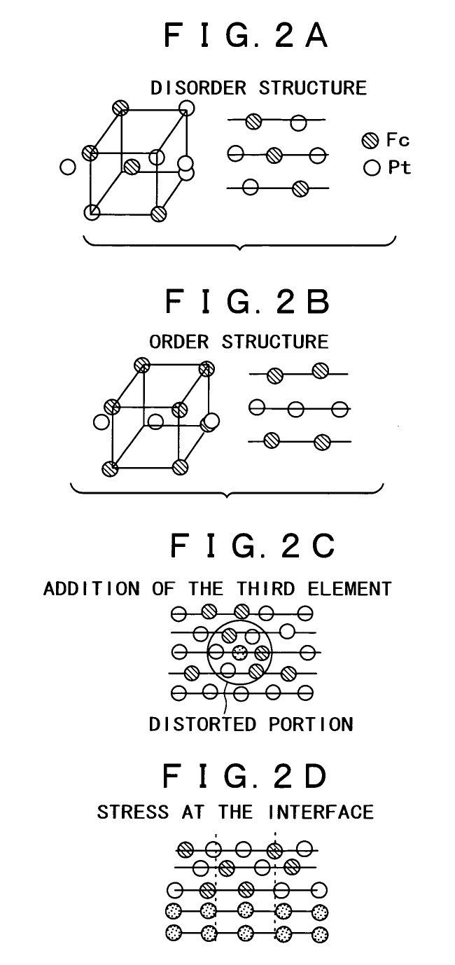

An L10 type alloy such as FePt alloy takes on an irregular face-centered-cubic structure as shown in FIG. 2A immediately after being fabricated either through deposition in high vacuum by sputtering or the like, or by the method using chemical synthesis as in the present invention. The irregular face-centered-cubic structure is characterized in that atoms of Fe and Pt are arranged at random. In order that the alloy may exhibit magnetic properties, the structure is required to be changed into the ordered (L10) structure in which atoms of Fe and Pt which are elements constituting the alloy core nano-particles are orderly aligned layer by layer as shown in FIG. 2B.

The state of FIG. 2A can be crystallographically referred to as a metastable state. The proper stable state is considered to be the state of FIG. 2B. However, the alloy core nano-particles invariably take on the irregular structure as shown in FIG. 2A when manufactured at around room temperature. When the alloy core nao-particles are subjected to a heat treatment, the nao-particles come to the stable state as shown in FIG. 2B due to the diffusion of the Fe and Pt atoms. This is the phenomenon called “order transition”. In general, the ordering temperature is as high as 550 to 600° C. This is due to the fact that the inter-diffusion coefficient of Fe and Pt which are elements constituting the alloy core nano-particles is small. The lowering in ordering temperature requires an increase in inter-diffusion coefficient of the elements constituting the alloy core nano-particles.

In the present invention, as a first method for lowering the ordering temperature of the core alloy, there is employed a method in which a third element having a different ion radius is added thereto. If a third element different in ion radius from the elements constituting the core alloy, for example, Fe (0.780 Å for 2+ ion) and Pt(0.80 Å for 2+ ion) is solid-solved in the core alloy, the surrounding portion of the atom of the added third element is distorted as shown in FIG. 2C. Each atom around such a distorted portion is present at a position unstable in terms of energy, so that diffusion tends to occur. Diffusion occurs with ease based on such a region as a core, and hence the ordering temperature of the core alloy nano-particles is lowered.

Table 1 shows the difference between the ion radius t2 of the element (Cu, Ag, Sn, or Sb) to be used as the third element and the ion radius t1 of the core element (Fe, Co, Pt, or Pd) constituting the ordered alloy (definition: (t2−t1/t1×100%)

TABLE 1

| | Cu²⁺ | Ag⁺ | Sn²⁺ | Sb³⁺ |
|---|---|---|---|---|
| Fe²⁺ | −6.41 | 47.40 | 19.23 | −2.56 |
| Co²⁺ | −2.05 | 54.36 | 24.83 | 2.01 |
| Pt²⁺ | −8.75 | 43.75 | 16.25 | −5.00 |
| Pd²⁺ | −15.1 | 33.72 | 8.14 | −10.00 |

If the difference in ion radius is too large, the third element will not be solid-solved in the ordered alloy of the core. From such a viewpoint, as the third element to be added, a material such as. Cu or Sb is superior to a noble metal such as Ag. More preferably, a material of which the value of the difference in ion radius from the element constituting the core alloy is single digit is desirably used.

As a second method for lowering the ordering temperature of the core alloy, there is employed a method in which the nano-particles of the core alloy are surrounded using an element having a different lattice constant as a shell. As the shell for surrounding the nano-particles, there is used a metal having a different lattice constant from the lattice constant of the ordered alloy constituting the nano-particles. By doing so, the position of the atoms present at the interface with the core alloy is expanded (or shrunk) by being pulled by the surrounding metal lattice as shown in FIG. 2D.

The atoms in the vicinity of the interface with the core alloy diffuse with ease, and hence ordering occurs at a lower temperature from the interface as a starting point. Herein, the lattice constants d1 of noble metal elements are as follows: Pd: 3.89 Å (cubic lattice), Ag: 4.09 Å (cubic lattice), Pt: 3.92 Å (cubic lattice), and Au: 4.08 Å (cubic lattice). The lattice constant d2 of the core alloy in unordered form is 3.90 Å for FePt. Thus, the differences in lattice constant when noble metals are used as the shells are shown in Table 2.

TABLE 2
Difference in lattice constant (definition: (d1 − d2)/d2
× 100%, the value of axis a is used for the ordered alloy)

| | Pd | Ag | Pt | Au |
|---|---|---|---|---|
| FePt | 0.26 | 4.87 | 0.51 | 4.61 |

When the difference in lattice constant is too large, it is conceivable that the atoms of the shell layer and the atoms of the core layer at the interface will not be epitaxially bonded to each other closely as shown in FIG. 2D. On the other hand, when the difference in lattice constant is too small, it is conceivable that less effects are produced. When the difference in lattice constant from the core alloy is not more than 5%, substantial effects of lowering the ordering temperature cannot be expected. Therefore, as a noble metal to be used as the shell for surrounding the core alloy, as shown in Table 3, an element of which the difference in lattice constant from the core alloy is not less than 5% and not more than 30% is more preferred.

TABLE 3
Differences in lattice constant from
preferred element group other than Ag

| | Cu | Sn | Pb | Sb | Bi |
|---|---|---|---|---|---|
| FePt | −7.18 | −18.46 | 26.9 | 10.51 | 16.7 |

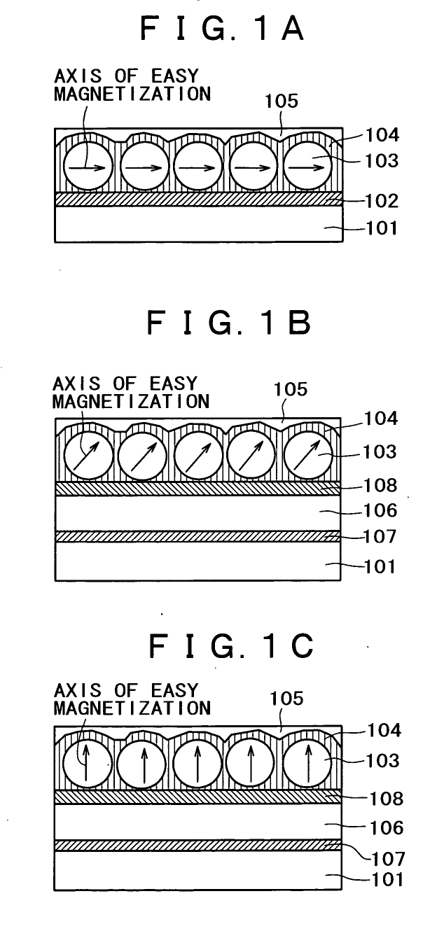

Below, the present invention will be described by way of examples with reference to the accompanying drawings. Each of FIGS. 1A to 1C shows one example of a magnetic recording medium in accordance with the present invention. FIG. 1A shows an example in which the present invention has been applied to a so-called in-plane recording medium wherein the angle formed between the axis of easy magnetization and the substrate plane is roughly zero degrees. FIG. 1B shows an example of a magnetic recording medium wherein the angle formed between the axis of easy magnetization and the substrate plane is roughly 45 degrees. FIG. 1C shows an example of a so-called perpendicular magnetic recording medium wherein the angle formed between the axis of easy magnetization and the substrate plane is 90 degrees.

In FIGS. 1A to 1C, a reference numeral 101 denotes a substrate (ex., glass or Al substrate); 102, an underlayer; 103, magnetic nano-particles; 104, a covering surrounding the magnetic nano-particles; 105, a surface protective film; 106, a soft magnetic underlayer (ex., FeTaC or CoZrNb); 107, an underlayer for the soft magnetic underlayer; and 108, an interlayer for cutting the magnetic interaction between the soft magnetic underlayer 106 and the magnetic nano-particles 103.

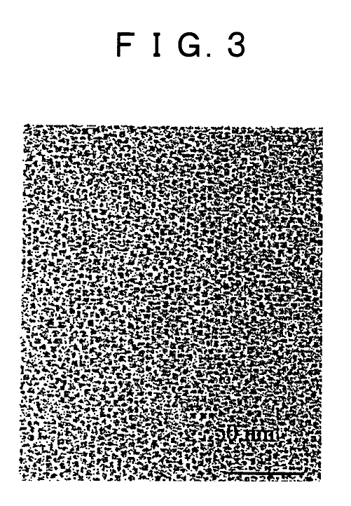

FIG. 3 is a diagram showing one example of a photograph of the magnetic recording medium of the present invention observed under a transmission electron microscope. Black points are magnetic nano-particles with an average nano-particle diameter of 5.5 nm. The bright area between the black points is a covering of carbon which is an organic compound. It is herein shown that the nano-particles are regularly separated from one another at a substantially uniform spacing by the covering of carbon. Further, in the example of FIG. 3, the nano-particle diameter dispersion of the magnetic nano-particles is 7%. The nano-particle diameter dispersion is desirably not more than 10%, and in particular, more preferably not more than 7%. With the magnetic recording medium of this example, the nano-particle diameter dispersion falls within the more preferred range.

The magnetic nano-particle to be used in the present invention is, first of all, composed of an alloy material prepared by adding any of Cu, Sn, Pb, Sb, and Bi to an alloy made of any of Fe and Co and any of Pt and Pd. Alternatively, it takes on a structure in which the alloy of any of Fe and Co and any of Pt and Pd serves as a core and Cu, Sn, Pb, Sb, or Bi (shell) surrounds therearound. Below, the reason why the alloy nano-particles of the material or the structure are preferred for manufacturing the magnetic recording media as shown in FIGS. 1A to 1C will be explained while describing a manufacturing method thereof.

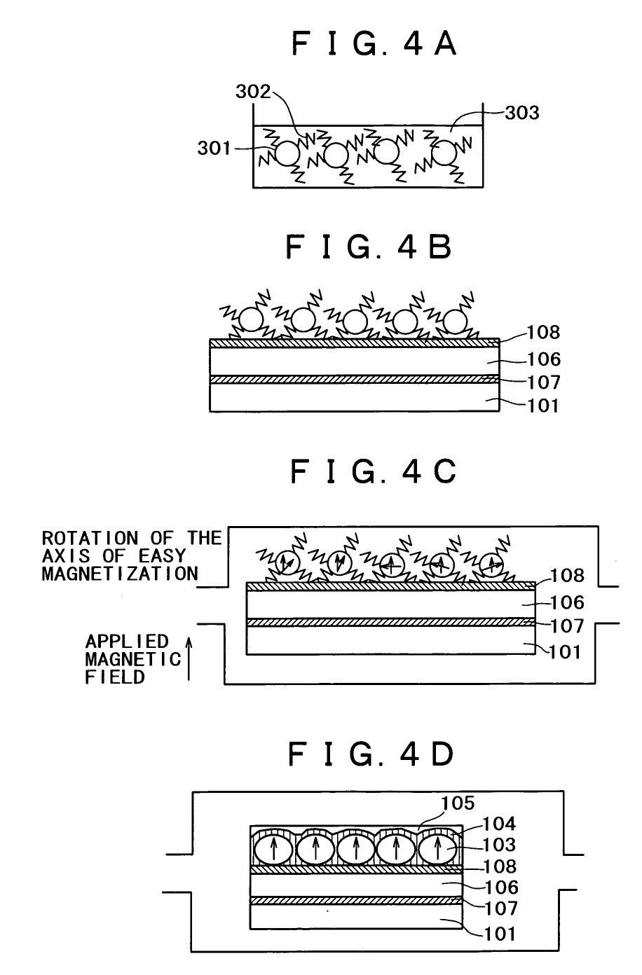

FIGS. 4A to 4D show one example of a manufacturing method of the magnetic recording medium of the present invention. First, as shown in FIG. 4A, alloy nano-particles with a diameter of 3 to 10 nm are chemically synthesized. The chemically synthesized nano-particles 301 are each surrounded by a carbon-containing organic compound 302 to form a colloid in an appropriate solvent 303. The alloy colloid particles are deposited in a monolayer on the underlayer 102 for FIG. 1A, or on the interlayer 108 for FIGS. 1B and 1C. The deposition can be accomplished by several methods including, for example, general methods in which an organic material is coated and deposited on a substrate, such as dip coating and spin coating, and a Langmuir-Blodgett method.

FIG. 4B shows the step. FIG. 4B shows one example for the case where the magnetic recording medium of FIG. 1B or 1C is manufactured. As is well known, the alloy particles of any of Fe and Co and any of Pt and Pd immediately after synthesis are in an irregular face-centered cubic (fcc) structure. The alloy particles do not exhibit magnetic properties in this state. In order that the alloy particles may exhibit magnetic properties, the following process must be performed. As shown in FIG. 4C, the alloy particles are heat-treated to induce an order-disorder transition, so that the crystal structure of the alloy particles undergoes a transition to an ordered L10 structure.

However, the temperature at which the transition occurs is generally as very high as 550 to 600° C. If such a high temperature heat treatment is performed, first, the nano-particles which have been aligned in a monolayer so carefully agglomerate together, and grow into a large agglomerate nano-particles. This increases the nano-particle diameter, which is unfavorable for implementing a high-density magnetic recording medium. Secondly, when the high temperature heat treatment is performed, the organic compound surrounding the alloy nano-particles 301 are solidified.

Originally, the crystalline axes of the alloy nano-particles deposited on the substrate are oriented at random. Therefore, the magnetic nano-particles magnetized after the heat treatment were also fixed by the organic compound surrounding the magnetic nano-particles with the axes of easy magnetization oriented at random. With a magnetic recording medium to be made available for actual use, it is essential that the directions of axes of easy magnetization are aligned in the same direction as much as possible. For this reason, such magnetic nano-particle film cannot be used as a magnetic recording medium.

Thirdly, in particular, when the magnetic nano-particle film is formed on the soft magnetic underlayer 106 as shown in FIGS. 1B and 1C, a high temperature heat treatment at 550 to 600° C. adversely affects the magnetic characteristics of the soft magnetic underlayer. Accordingly, it is not possible to keep desirable characteristics. In the present invention, for synthesis, to an alloy composed of any of Fe and Co and any of Pt and Pd, a third element, specifically, Cu, Sn, Pb, Sb, Bi, or the like is added. Thus, the synthesis is accomplished. These atoms enter into the lattice positions occupied by Fe or Co and Pt or Pd to generate a stress in the crystal.

In general, the order-disorder transition is triggered by the stress in the crystal. Accordingly, for the alloy to which the appropriate third atoms have been added as in this example, the temperature causing the order-disorder transition is lowered largely. The relationship between the amount of the third element added and the temperature causing the order-disorder transition varies depending upon the kinds of the base alloy and the atoms to be added. In general, an amount of the atoms added in a range of 5 to 20% lowers the order-disorder transition temperature to not more than 300° C. In particular, when Cu is added in an amount of about 10% to a preferred composition, for example, FePt nano-particles, it is possible to largely lower the temperature to 250° C.

Alternatively, another method for lowering the ordering temperature of the alloy nano-particles is as follows. For synthesis, the alloy composed of any of Fe and Co and any of Pt and Pd is first synthesized. Then, the shell portion composed of Cu, Sn, Pb, Sb, Bi, or the like is fabricated so as to surround the core of the alloy. By doing so, a large stress acts on the interface of the alloy core with the shell. As a result, it is possible to set the order-disorder transition temperature at generally not more than 300° C.

If the alloy nano-particles of which the order-disorder transition temperature has been thus lowered to not more than 300° C. are used, it is possible to align the axes of easy magnetization of the magnetic nano-particles in one direction by performing a heat treatment in a magnetic field as shown in FIG. 4C. Then, as shown in FIG. 4D, the heat treatment temperature is raised up to the solidification temperature of the organic compound (ex., carbon) surrounding the magnetic nano-particles 301 to sufficiently solidify the organic compound. Thus, the magnetic nano-particles are fixed to the substrate with the axes of easy magnetization of the magnetic nano-particles held in a prescribed direction.

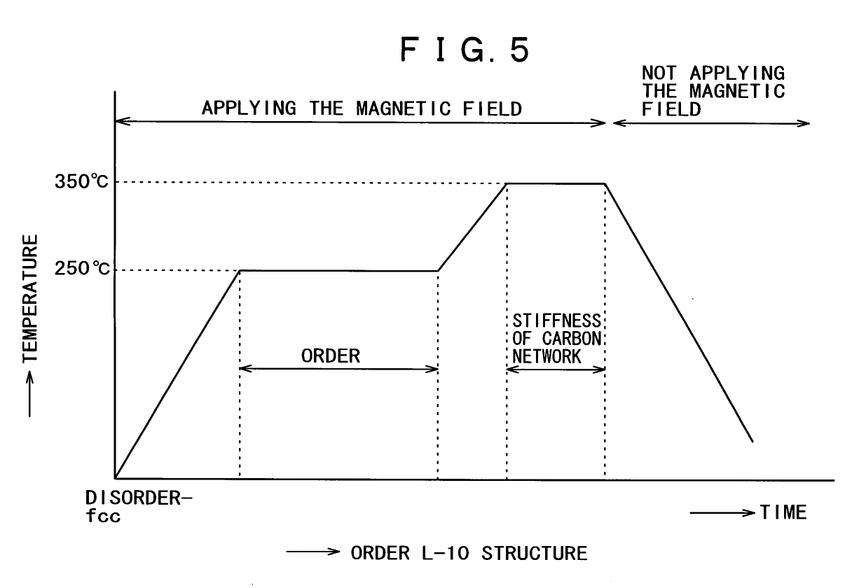

FIG. 5 shows the changes in temperature when the foregoing heat treatment in a magnetic field is performed. The alloy nano-particles deposited in a monolayer on the substrate as shown in FIG. 4C are heated under a magnetic field, up to the temperature at which the order-disorder transition is initiated, for example, 250° C. At this heat treatment temperature, the organic compound surrounding the alloy nano-particles has not yet been solidified completely. Therefore, the alloy nano-particles change into an L10 structure through the order-disorder transition, so that the directions of magnetization of the alloy nano-particles magnetized in random directions rotate in the direction of applied magnetic field to be uniformly aligned.

By setting the direction of magnetic field to be applied at this step at a given angle with the substrate plane, it is possible to set the direction of axis of easy magnetization along the direction at a desirable angle with respect to the substrate plane. For example, if the direction of magnetic field to be applied is set parallel to the substrate plane, it is possible to form the in-plane magnetic recording medium as shown in FIG. 1A. If the direction of magnetic field is set to be the direction at an angle of 45 degrees with respect to the substrate plane, it is possible to form the magnetic recording medium as shown in FIG. 1B. If the direction of magnetic field is set to be the direction at an angle of 90 degrees with respect to the substrate plane, it is possible to form the perpendicular magnetic recording medium as shown in FIG. 1C. Subsequently, the heat treatment temperature is raised up to more than 300° C., for example, up to 350° C., so that the carbon-containing organic compound around the nano-particles is sufficiently solidified. The respective magnetic alloy nano-particles are firmly fixed in the process of solidification. Finally, the magnetic field is cut, and the temperature is decreased to room temperature. Thus, a protective film 105 for anti-sliding purpose is formed on the surface, completing the medium manufacturing process.

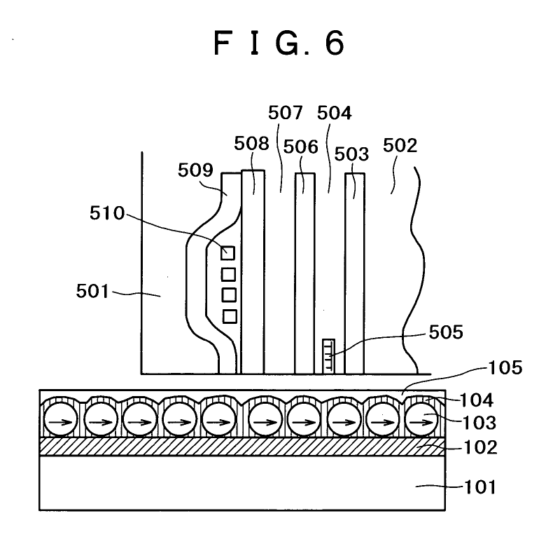

FIG. 6 is a diagram for showing a schematic configuration of a hard disk drive using a magnetic recording medium composed of a substrate 101, an underlayer 102, magnetic nano-particles 103 of which the-axes of easy magnetization form an angle of roughly zero degrees with respect to the substrate plane, a covering 104 surrounding the magnetic nano-particles, and a surface protective film 105, and a merged-type-magnetic head having a reader using a magneto-resistive effect for reproduction, and a writer in a ring form for recording.

Herein, a reference numeral 502 denotes a substrate constituting the base portion of a magnetic slider; 503, a lower shield; 504 an insulating film; 505, a magnetic sensor applying a magneto-resistive effect showing an anisotropic magneto-resistive effect (AMR) or a giant-magneto-resistive effect (GMR); 506, an upper shield; 507, a spacer layer; 508, a lower magnetic pole; 509, an upper magnetic pole; 510, a coil for inducing a magnetic field between the magnetic poles; and 501, a protective film. The magnetic sensor film indicated by 505 is not shown in detail. When the GMR is used, the magnetic sensor film is composed of a multilayered film of, for example, underlayer/anti-ferromagnetic layer/pinned layer/metal layer/free layer/cap layer. Further, permanent magnets for inhibiting the instability in magnetization of the free layer are disposed at opposite ends of the sensor film along the direction perpendicular to the paper plane.

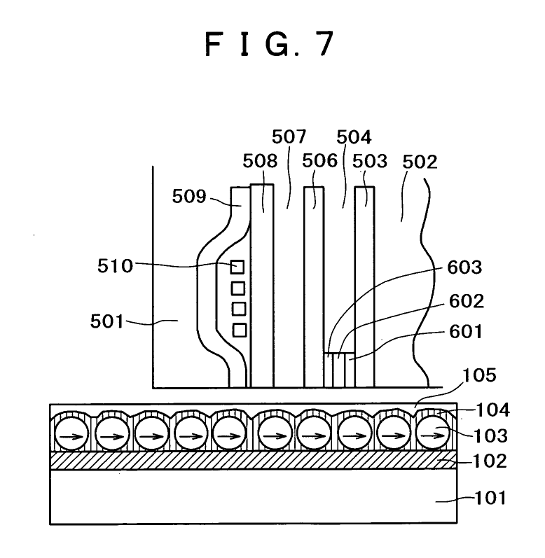

FIG. 7 shows an example of the hard disk drive of FIG. 6 in which a reader of a CCP (current perpendicular to plane) system for passing a detection current perpendicularly to the sensor film surface is used as the reader using a magneto-resistive effect. A reference numeral 601 denotes a lower electrode layer; 602, a magnetic sensor film applying a magneto-resistive effect; and 603, an upper electrode layer. A current passes between the upper shield 506 and the lower shield 503. When the GMR is used, as with FIG. 6, the magnetic sensor film is composed of a multilayered film of, for example, underlayer/anti-ferromagnetic layer/pinned layer/metal layer/free layer/cap layer. When a tunnel magneto-resistive effect (TMR) is used, the magnetic sensor film is composed of a multilayered film of, for example, underlayer/anti-ferromagnetic layer/pinned layer/insulating layer/free layer/cap layer. Further, as with FIG. 6, permanent magnets for inhibiting the instability in magnetization of the free layer are disposed at opposite ends of the sensor film along the direction perpendicular to the paper plane.

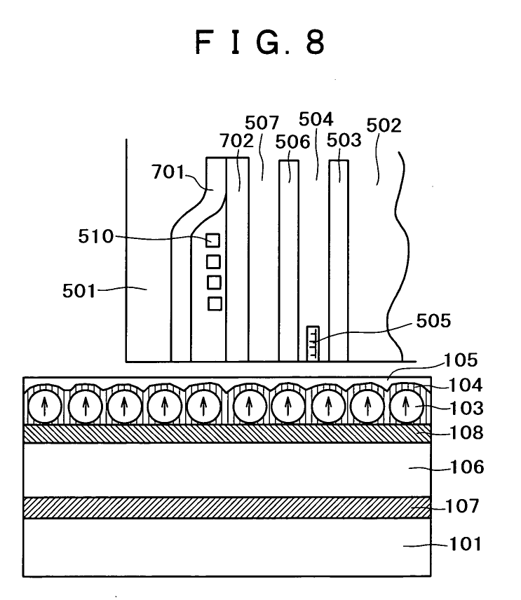

FIG. 8 is a diagram for showing a schematic configuration of a hard disk drive using a magnetic recording medium composed of a substrate 101, an underlayer 108, a soft magnetic underlayer 106, an interlayer 107, magnetic nano-particles 103 of which the axes of easy magnetization form an angle of roughly 90 degrees with respect to the substrate plane, a covering 104 surrounding the magnetic nano-particles, and a surface protective film 105, a merged-type-magnetic head having a reader using a magneto-resistive effect for reproduction, and a single-pole-type writer for perpendicular magnetic recording. Herein, the reference numerals 501 to 507 respectively denote the same elements as in FIG. 6. Further, even if a reader using the magneto-resistive effect of the CPP type obtained by changing the elements 504 and 505 into the elements 601 to 603 of FIG. 7 is used, the same effects are produced. Further, reference numerals 701 and 702 denote a main magnetic pole and a sub magnetic pole of a single-pole-type writer, respectively.

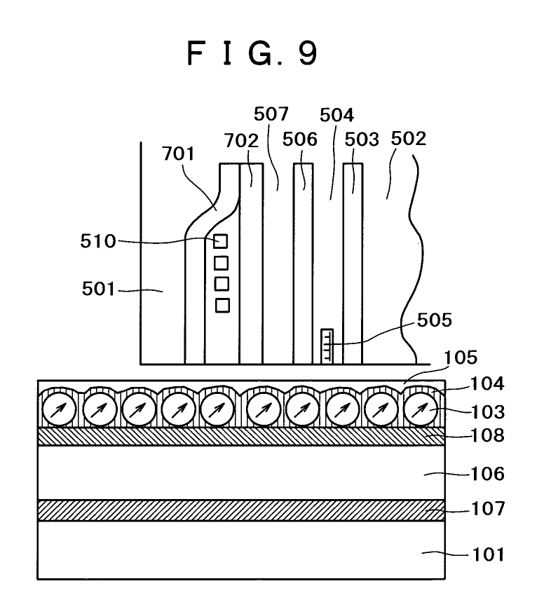

FIG. 9 shows an example of the hard disk drive of FIG. 8, using a magnetic recording medium in which the axes of easy magnetization of the magnetic nano-particles 103 form an angle of roughly 45 degrees with respect to the substrate plane.

The magnetic recording performances of the magnetic recording medium of the present invention will be described taking the magnetic recording medium used in FIG. 8 as an example. For the magnetic recording medium used in FIG. 8, as indicated from the TEM photograph of FIG. 3, the average diameter of nano-particles was 6.5 nm and the spacing between the nano-particles was about 2 nm. The alloy nano-particles used are the nano-particles with a composition of (FePt)₈₉Cu₁₁. The coercive force Hc in the direction perpendicular to the film surface of the nano-particle film determined by a VSM was 875 kA/m (11 kOe) and the magnetic anisotropy energy Ku determined by a torque magnetometer was 1.46×10⁶ J/m². The KuV/kT at this stage is estimated to be about 54, which is the value enough for ensuring the thermal stability. Thus, it was possible to obtain the characteristics unobtainable with a conventional magnetic nano-particle medium in which the axes of easy magnetization are oriented three dimensionally at random.

Further, a recording experiment was carried out by using a single-pole-type head expected to be capable of generating a maximum magnetic field of 1.2 MA/m (15 kOE) by micro-magnetic calculations using a three-dimensional finite element method. As a result, an overwrite performance of more than 35 dB at a magnetomotive force of 0.3 AT (recording of a signal of 400 kFCl on a signal of 60 kFCl) was shown. This indicated that the hard disk drive composed of a combination of the magnetic recording medium having an alloy nano-particle layer and a single-pole-type writer in accordance with the present invention has a sufficient recording performance.

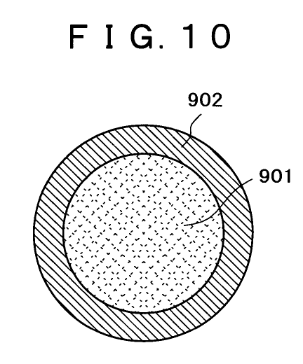

The alloy nano-particles used for the magnetic recording medium of FIG. 8 are the nano-particles of the type in which a third element has been added. In the nano-particles of this type, the third element is incorporated in the alloy structure itself. Therefore, the magnetic properties such as the magnetic anisotropy energy and the coercive force to be exhibited are smaller in value than the magnetic properties exhibited by pure L10 type alloys. In order to increase the magnetic anisotropy energy Ku and lower the disorder-order transition temperature of the L10 alloy for further enhancing the thermal stability, the following procedure is effective. As shown in FIG. 10, nano-particles of a so-called core-shell structure, in each of which for example, a metal 902 such as Cu surrounds around, for example, a FePt core particle 901, are chemically synthesized. The resulting nano-particles are deposited on the substrate for use as a magnetic recording medium.

The average diameter of the alloy nano-particles obtained as a result of the chemical synthesis was 6.5 nm. A high resolution TEM observation indicates that the nano-particle diameter of the FePt portion of the core was 5.5 nm. The coercive force Hc in the direction perpendicular to the film surface of the nano-particle film determined by a VSM was 1590 kA/m (20 kOe) and the magnetic anisotropy energy determined by a torque magnetometer was 3×10⁶ J/m². In this step, the KuV/kT was 63, indicating that the film is thermally more stable than the above-described example.

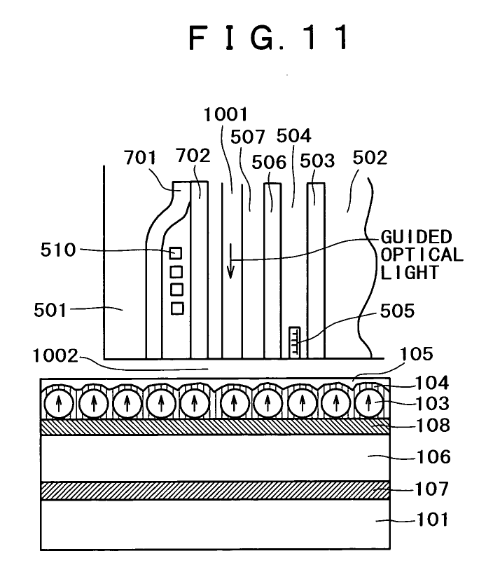

However, in order to perform magnetic recording on the magnetic recording medium having such a high magnetic anisotropy energy, a magnetic field strength as high as not less than 2385 kA/m (30 kOe) is required. Thus, it is impossible to generate such a large magnetic field strength with a writer using a material having a saturation magnetic flux density of not more than 2.4 T. Under such circumstances, in this example, the following method is adopted. For example, as shown in FIG. 11, an optical waveguide 1001 for guiding a light is disposed in proximity to the main magnetic pole 701 of the single-pole-type writer for recording. Thus, the nano-particle layer is heated by a light 1002 emitted from the optical waveguide 1001. As a result, the coercive force Hc of the L10 alloy is reduced to perform recording. The wavelength of the light to be used is desirably a wavelength such that the light will be absorbed in the nano-particle layer, for example, 350 to 1600 nm. However, visible light, particularly, violet light wavelengths are preferred for reducing the size of the optical waveguide and reducing the emitted light size.

The temperature dependence of the coercive force Hc of the nano-particle layer was measured. As a result, it was observed that the coercive force Hc of the nano-particle layer was reduced roughly linearly with an increase in temperature, and that it was 875 kA/m (11 kOe) at a temperature of 200° C. Then, the optical power to be inputted to the optical waveguide was controlled so that the temperature of the nano-particle layer becomes 200° C. Thus, a recording experiment was carried out. As a result, when a single-pole-type head expected to be capable of generating a maximum magnetic field of 1.2 MA/m (15 kOe) was used, an overwrite performance of more than 35 dB at a magnetomotive force of 0.3 AT (recording of a signal of 400 kFCl on a signal of 60 kFCl) was observed. This indicated that the hard disk drive composed of a combination of the magnetic recording medium having a nano-particle layer and the single-pole-type writer in accordance with the present invention has a sufficient recording performance.

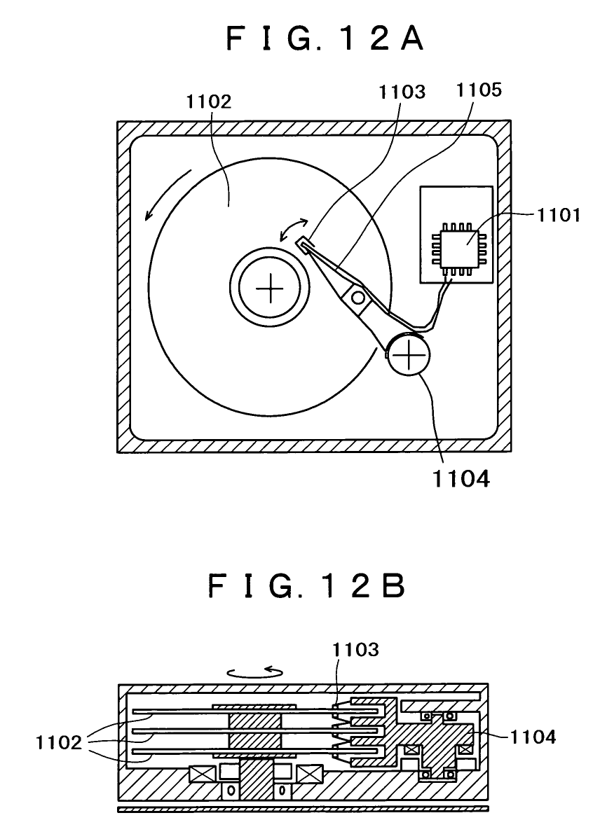

FIGS. 12A and 12B show a schematic diagram of a hard disk drive using the magnetic recording medium of the present invention (however, the enlargement factor of the diagram is not uniform). FIG. 12A is a plan view, and FIG. 12B is a cross-sectional view. The hard disk drive performs recording and reproduction of a magnetized signal on a disk 1102 in which the magnetic recording medium is formed by a magnetic head 1103 attached on a slider fixed at the tip of a suspension arm 1105. The processing of the signal reproduced by the magnetic head 1103 is performed by a circuit 1101. Further, the movement of the head to a prescribed information recorded position is performed by a rotary actuator 1104.

### Other Embodiments

The present invention includes, but is not limited to, the following additional embodiments.

A hard disk drive is provided that comprises a magnetic recording medium including, a substrate, and a magnetic recording layer formed on the substrate, the magnetic recording layer having an organic compound and alloy nano-particles surrounded by the organic compound, wherein the alloy nano-particles aligned substantially uniformly along a direction at an angle of roughly 0 degrees with respect to the substrate to form axes of easy magnetization, and wherein the alloy nano particles are configured to undergo a transition into an L10 structure at an ordering temperature lower than a stiffness, or cure, temperature of the organic compound to exhibit magnetic properties, and wherein the organic compound is solidified with the axes of easy magnetization; and a merged-type-magnetic head including a reader configured to use a magneto-resistive effect and to use a writer in a ring form.

A hard disk drive is provided that comprises a magnetic recording medium, comprising: a substrate; a soft magnetic underlayer on the substrate; and a magnetic recording layer formed on the substrate with the soft magnetic layer interposed therebetween, the magnetic recording layer comprising an organic compound and alloy nano-particles surrounded by the organic compound and arranged at a substantially uniform spacing, the alloy nano-particles undergoing a transition into an L10 structure at an ordering temperature lower than a stiffness, or cure, temperature of the organic compound to exhibit magnetic properties, wherein the organic compound has been solidified with the axes of easy magnetization of the alloy nano-particles aligned substantially uniformly along a direction at an angle of roughly 45 degrees or roughly 90 degrees with respect to the substrate plane; and a merged-type-magnetic head comprising a reader using a magneto-resistive effect and a single-pole-type writer for perpendicular magnetic recording.

This hard disk drive may have a light with a wavelength of 350 to 1600 nm used as the energy generation means.

A hard disk drive is provided that comprises a magnetic recording medium, comprising: a substrate; and a magnetic recording layer formed on the substrate, the magnetic recording layer comprising an organic compound and alloy nano-particles surrounded by the organic compound and arranged at a substantially uniform spacing, the alloy nano-particles undergoing a transition into an L10 structure at an ordering temperature lower than a stiffness temperature of the organic compound to exhibit magnetic properties, wherein the organic compound has been solidified with the axes of easy magnetization of the alloy nano-particles aligned substantially uniformly along a specific direction with respect to the substrate plane; an energy generation means for applying a recording energy to the magnetic recording medium; an energy focusing means for focusing the recording energy onto the recording medium; a magnetic field generation means for generating a magnetic field in the vicinity of the focus position of the recording energy; and a reader using a magneto-resistive effect for reproducing a signal recorded on the recording medium.

A method for manufacturing a magnetic recording medium is provided that comprises chemically synthesizing alloy nano-particles surrounded by an organic compound so as to be aligned substantially uniformly along a specific direction with respect to a substrate to form axes of easy magnetization; placing the alloy nano-particles on the substrate; applying heat energy to the alloy nano-particles such that the alloy nano-particles are configured to undergo an order-disorder transition into an L10 structure at an ordering temperature lower than a stiffness temperature of the organic compound to exhibit magnetic properties; solidifying the organic compound at a higher temperature than the ordering temperature while applying a magnetic field in a specific direction to the alloy nano-particles having the magnetic properties; and forming a magnetic recording layer on the substrate in such a state that the organic compound is solidified with the axes of easy magnetization.

This method may be such that the chemically synthesizing step includes at least one of a step of adding at least one non-magnetic element to the alloy nano-particles and a step of forming a covered layer comprising at least one non-magnetic element as the surrounding surface of each of the alloy nano-particles.

This method may be such that each of the alloy nano-particles comprises an alloy of any of Fe and Co and any of Pt and Pd as a base, and the non-magnetic element to be added thereto is any of Cu, Sn, Pb, Sb, and Bi.

This method may be such that each of the alloy nano-particles comprises an alloy of any of Fe and Co and any of Pt and Pd as a core, and the element constituting the layer covering therearound is any of Cu, Sn, Pb, Sb, Bi, and Ag.

A method for manufacturing a magnetic recording medium is provided that comprises preparing alloy nano-particles comprising an alloy which will undergo a transition to an L10 structure through an order-disorder transition to exhibit magnetic properties, and at least one non-magnetic element added thereto, or a covering film comprising at least one non-magnetic element covering therearound, and chemically synthesizing the alloy nano-particles so as to be arranged at a substantially uniform spacing and surrounded by an organic compound; applying the alloy nano-particles onto a substrate; heat-treating a nano-particle film applied on the substrate at an ordering temperature lower than a stiffness temperature of the organic compound so as to effect an order-disorder transition of the nano-particles while applying a magnetic field in a specific direction to the alloy nano-particles; and solidifying the organic compound at a higher temperature than the ordering temperature while applying a magnetic field in a specific direction to the alloy nano-particles, wherein a magnetic recording layer is formed on the substrate in such a state that the organic compound has been solidified with the axes of easy magnetization of the alloy nano-particles aligned substantially uniformly along a specific direction with respect to the substrate.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for manufacturing a magnetic recording medium comprising:
chemically synthesizing alloy nano-particles surrounded by an organic compound so as to be aligned substantially uniformly along a first direction with respect to a substrate to form axes of easy magnetization;
placing the alloy nano-particles on the substrate;
applying heat energy to the alloy nano-particles such that the alloy nano-particles are configured to undergo an order-disorder transition into an L10 structure at an order-disorder transition temperature lower than a solidification temperature of the organic compound to exhibit magnetic properties;
solidifying the organic compound at a higher temperature than the order-disorder transition temperature while applying a magnetic field in a second direction to the alloy nano-particles having the magnetic properties; and
forming a magnetic recording layer on the substrate in such a state that the organic compound is solidified with the axes of easy magnetization.

2. This method according to claim 1, wherein the chemically synthesizing step includes at least a step of adding at least one non-magnetic element to the alloy nano-particles and a step of forming a covered layer including at least one non-magnetic element as a surrounding surface of each of the alloy nano-particles.

3. This method according to claim 1, wherein each of the alloy nano-particles includes a base alloy of one of
Fe and Pt,
Fe and Pd,
Co and Pt,
Co and Pd, and
the non-magnetic element to be added thereto is one of Cu, Sn, Pb, Sb, and Bi.

4. This method according to claim 1, wherein each of the alloy nano-particles includes a base alloy core of one of
Fe and Pt,
Fe and Pd,
Co and Pt,
Co and Pd, and
the element constituting the layer covering therearound is one of Cu, Sn, Pb, Sb, Bi, and Ag.

5. A method for manufacturing a magnetic recording medium comprising:
preparing alloy nano-particles including an alloy which will undergo a transition to an L10 structure through an order-disorder transition to exhibit magnetic properties, and at least one non-magnetic element added thereto, or a covering film including at least one non-magnetic
chemically synthesizing the alloy nano-particles so as to be arranged at a substantially uniform spacing and surrounded by an organic compound;
applying the alloy nano-particles onto a substrate;
heat-treating a nano-particle film applied on the substrate at an order-disorder transition temperature lower than a solidification temperature of the organic compound so as to effect an order-disorder transition of the nano-particles while applying a magnetic field in a first direction to the alloy nano-particles; and
solidifying the organic compound at a higher temperature than the order-disorder transition temperature while applying a magnetic field in a second direction to the alloy nano-particles,
wherein a magnetic recording layer is formed on the substrate such that the organic compound has been solidified with the axes of easy magnetization of the alloy nano-particles aligned substantially uniformly along a third direction with respect to the substrate.
